(19) United States
(12) Patent Application Publication
(10) Pub. No.: US 2020/0128286 A1
(43) Pub. Date: Apr. 23, 2020

(54) LIVE STREAMING SOCIAL INTERACTION TO TRIGGER PRODUCT SEARCH

(71) Applicant: International Business Machines Corporation, Armonk, NY (US)

(72) Inventors: Kelley Anders, East New Market, MD (US); Lisa Seacat Deluca, Baltimore, MD (US); Jeremy R. Fox, Goergetown, TX (US); Jeremy A. Greenberger, San Jose, CA (US)

(21) Appl. No.: 16/162,478

(22) Filed: Oct. 17, 2018

(51) Int. Cl. H04N 21/254; H04N 21/2187; G06Q 30/06; G06K 9/00

(52) U.S. Cl. CPC H04N 21/2542; G06K 9/00671; G06Q 30/0627; H04N 21/2187

(57) ABSTRACT

Aspects of the present invention disclose a method for identifying products in a live stream. The method includes one or more processors determining that a user provides an interaction with a live stream. The method further includes capturing a portion of the live stream that corresponds to the user interaction with the live stream. The method further includes identifying a first product that is depicted in the captured portion of the live stream that corresponds to the user interaction. The method further includes presenting an option to purchase the product to the user. The method further includes determining whether the user selects to purchase the product.

### BACKGROUND OF THE INVENTION

The present invention relates generally to social computing, and more particularly to social interaction with live.

In recent years, a wealth of opportunities for sales-based innovations have arose with the continued growth in popularity of online shopping. Within the World Wide Web (WWW) and the Internet, users can access an infinite source of sites, including social media sites where live streaming events are used for entertainment and marketing products directly to targeted consumer groups.

Live streaming is multimedia that is simultaneously recorded and broadcast in real-time to an end-user. User interaction is a major component in the popularity of live streaming events, because user interaction gives a user the ability to interact with the broadcaster during the live event. Live streaming events can also include metadata.

Metadata is “data about data” and includes different types of metadata such as structural, statistical, and descriptive metadata. Structural metadata includes information about the design and specification of data structures (i.e., data about the containers of data). Statistical metadata includes information that describes processes that collect, process, or produce statistical data; such metadata are also called process data. Descriptive metadata includes information about individual instances of application data or the data content. In broadcast industry, metadata is linked to audio and video broadcast media to identify, describe, and classify media. Metadata can be written into a digital media to indicate various types of information that is associated with the media, such as who owns the media, copyright and contact information, what camera created the media, along with exposure information and descriptive information, such as keywords associated with the media. Media that includes metadata can be more easily searchable (e.g., via Internet searching). Metadata also assists in resource discovery by allowing resources to be found (e.g., via Internet searching) by relevant criteria, identifying resources, and associating similar resources.

### SUMMARY

Aspects of the present invention disclose a method, computer program product, and system for identifying products in a live stream. The method includes determining, by one or more processors, that a user provides an interaction with a live stream. The method further includes capturing, by one or more processors, a portion of the live stream that corresponds to the user interaction with the live stream. The method further includes identifying, by one or more processors, a first product that is depicted in the captured portion of the live stream that corresponds to the user interaction. The method further includes presenting, by one or more processors, an option to purchase the product to the user. The method further includes determining, by one or more processors, whether the user selects to purchase the product. In another embodiment, the method further includes in response to determining that the user selects to purchase the first product, adding, by one or more processors, the first product to a shopping cart associated with the user.

### BRIEF DESCRIPTION OF THE DRAWINGS

FIG. 1 is a functional block diagram of a data processing environment, in accordance with an embodiment of the present invention.

FIG. 2 is a flowchart depicting operational steps of a program for identifying and presenting products in a live streaming event in response to a user interaction with the live streaming event, in accordance with embodiments of the present invention.

FIG. 3 depicts a block diagram of components of a computing system representative of the server of FIG. 1, in accordance with an embodiment of the present invention.

### DETAILED DESCRIPTION

Embodiments of the present invention allow for a user to add a product identified within a live streaming event to the shopping cart of the user in accordance with a user interaction, eliminating the need for the error-prone manual searching and processing by the user via a search engine. A portion of the live streaming event is captured and analyzed to identify depicted products that are available for purchase. The products of the live streaming event are associated with content and metadata utilizing visual recognition and speech-to-text techniques in accordance with a user interaction without any human assistance. The products are identified utilizing a real-time dynamic product data search and presented to the user for collection or purchase.

Some embodiments of the present invention recognize that the product search can be defined by user preferences. Thus, various embodiments of the present invention can derive products from a predefined selective site or through a wider search with a broad result returned. For example, a blogger is live streaming a product review and predefines that the search results for products are limited to a specific website (e.g., a website associated with the blogger). Alternatively, a blogger is live streaming a product review and does not define a limitation, allowing product results to be returned from all online stores.

Embodiments of the present invention recognize that challenges exist in the process of finding the correct product and a retailer that carries the product that a user sees in a live stream. A user searching and finding a product seen in a live stream using a search engine is error-prone and requires manual processing on the part of the user. Various embodiments of the present invention overcome these challenges by allowing a user to seamlessly add the correct product in a live stream to a shopping cart without further research, further click-throughs, or taking note of the product name. Additionally, storing and analyzing the amount of data associated with an entire live stream requires allocation of a sizeable amount of storage and processing resources of a computer. Whereas, various embodiments of the present invention improve the efficiency and utilization of computer resources by analyzing a particular portion of a live stream (e.g., a portion that corresponds to a user interaction with the live stream), thus the computer has more processing and storage resources to perform additional tasks.

Implementation of embodiments of the invention may take a variety of forms, and exemplary implementation details are discussed subsequently with reference to the Figures.

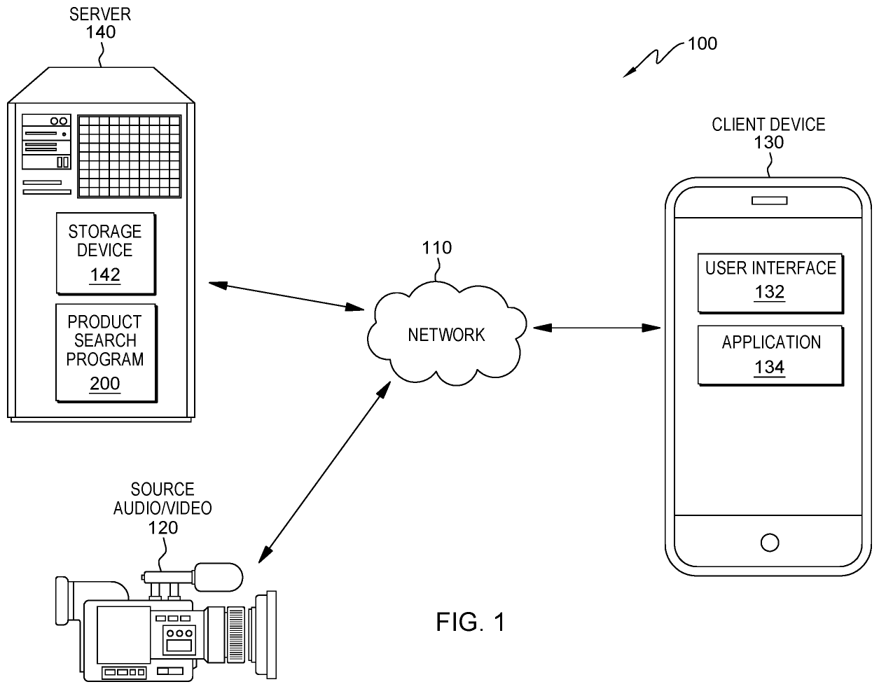

The present invention will now be described in detail with reference to the Figures. FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

An embodiment of data processing environment 100 includes audio/video source 120, client device 130, and server 140, all interconnected over network 110. In an example embodiment, client device 130 accesses data (e.g., a video stream, an audio stream, etc.) from audio/video source 120 that utilizes hosting services of server 140. In one embodiment, audio/video source 120, client device 130, and server 140 communicate through network 110. Network 110 can be, for example, a local area network (LAN), a telecommunications network, a wide area network (WAN), such as the Internet, or any combination of the three, and include wired, wireless, or fiber optic connections. In general, network 110 can be any combination of connections and protocols that will support communications between audio/video source 120, client device 130, and server 140, in accordance with embodiments of the present invention.

In various embodiments of the present invention, audio/video source 120 can be a live radio, live television, Internet television, Internet radio, live blogging, live streaming or any other live transmission of media, in accordance with embodiments of the present invention. In general, audio/video source 120 is a streaming media source, which is simultaneously recorded and broadcast in real-time to an end user. In one embodiment, audio/video source 120 transmits data to server 140 over network 110. Additionally, server 140 stores the data from audio/video source 120, and simultaneously broadcasts (i.e., live streams) the data of audio/video source 120 to client device 130 over network 110. For example, server 140 receives transmission of a product review of a blogger and server 140 stores the audio and video data of the product review and broadcasts the audio and video data via a social media site over the Internet to a viewer.

In various embodiments of the present invention, client device 130 may be a workstation, personal computer, personal digital assistant, mobile phone, or any other device capable of executing computer readable program instructions, in accordance with embodiments of the present invention. In general, client device 130 is representative of any electronic device or combination of electronic devices capable of executing computer readable program instructions.

Client device 130 includes user interface 132 and application 134. User interface 132 is a program that provides an interface between a user of client device 130 and a plurality of applications that reside on the client device. A user interface, such as user interface 132, refers to the information (such as graphic, text, and sound) that a program presents to a user, and the control sequences the user employs to control the program. A variety of types of user interfaces exist. In one embodiment, user interface 132 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 132 is a script or application programming interface (API).

Application 134 is a computer program designed to run on the client device 130. An application frequently serves to provide a user with similar services accessed on personal computers (e.g., web browser, live stream software, presentation software, mapping program, or playing music, other media, etc.). In an example embodiment, application 134 is a web browser that an individual utilizing client device 130 can utilize to view live streaming content. Additionally, an individual can utilize application 134 (e.g., the web browser) to provide interactions with the live streaming content by utilizing user interface 132. In another example embodiment, application 134 is live streaming application software that an individual can utilize to view the products returned in accordance with the interaction of the individual with the live streaming content. Additionally, the individual can utilize application 134 (e.g., the live streaming application software) to select products to purchase by utilizing user interface 132.

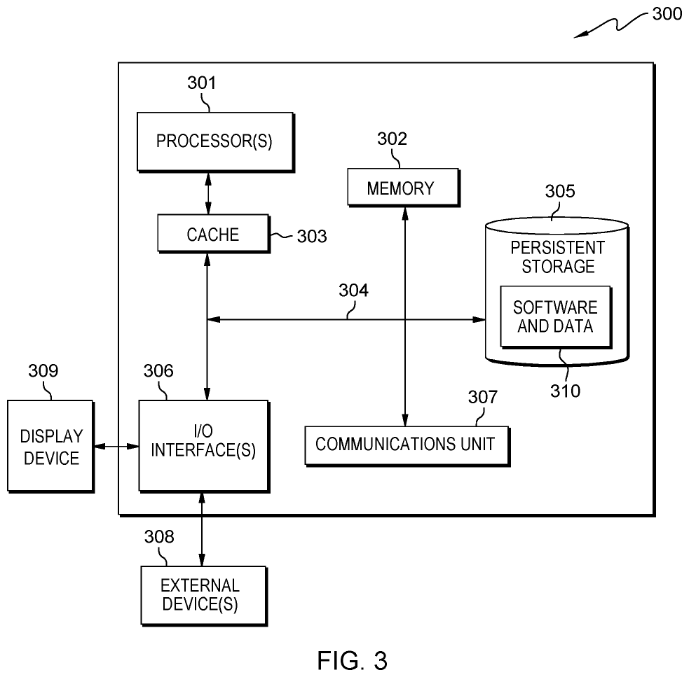

In various embodiments of the present invention, server 140 may be a desktop computer, a computer server, or any other computer systems, known in the art. In certain embodiments, server 140 represents computer systems utilizing clustered computers and components (e.g., database server computers, application server computers, etc.), which act as a single pool of seamless resources when accessed by elements of data processing environment 100 (e.g., client device 130). In general, server 140 is representative of any electronic device or combination of electronic devices capable of executing computer readable program instructions. Server 140 may include components as depicted and described in further detail with respect to FIG. 3, in accordance with embodiments of the present invention.

Server 140 includes storage device 142 and product search program 200. Storage device 142 can be implemented with any type of storage device, for example, persistent storage 305, which is capable of storing data that may be accessed and utilized by server 140 and client device 130, such as a database server, a hard disk drive, or a flash memory. Product search program 200 analyzes a portion of a live streaming event to identify products within a captured portion and can add the products to a shopping cart in accordance with a user interaction with the live streaming event, in accordance with embodiments of the present invention. For example, a user interaction is a user clicking a “like” button during a live stream of a product review of a blogger from a social media broadcast. Additionally, product search program 200 identifies a set of glasses within a screenshot of the live stream of a product review of a blogger and adds the set of glasses the blogger is reviewing in the live stream (i.e., depicted in the live stream) to a shopping cart of the user.

In other embodiments, storage device 142 can represent multiple storage devices within server 140. Storage device 142 stores a plurality of types of data, such as dynamic data, streaming media, metadata, etc. In general, dynamic data is information that is periodically updated (i.e., changes asynchronously over time as new information becomes available.). In one embodiment, when a user interacts with a live streaming event, product search program 200 returns dynamic data from WAN (i.e., the Internet) that is stored in storage device 142. For example, a user clicks a “like” button during a portion of a product review of a blogger from a social media broadcast and product search program 200 returns products from Internet sites that are added to a shopping cart. Additionally, the user clicks “like” button during a different portion of the product review of a blogger from a social media broadcast and product search program 200 returns additional products that are added to the shopping cart (i.e., the products returned and added to the shopping cart are dynamic data as the products and the shopping cart contents change in accordance with the interaction of the user with the live streaming event).

In another embodiment, server 140 receives data (e.g., streaming media) from audio/video source 120 over network 110 that is stored in storage device 142. For example, server 140 receives audio and video data of a product review of a blogger from a social media broadcast and stores the audio and video data, which includes metadata, in storage device 142. In yet another embodiment, server 140 receives metadata of a captured portion of the live streaming event of audio/video source 120 and stores the metadata in storage device 142. For example, server 140 receives data about a set of glasses in a screenshot of a product review of a blogger from a social media broadcast and stores the metadata in storage device 142.

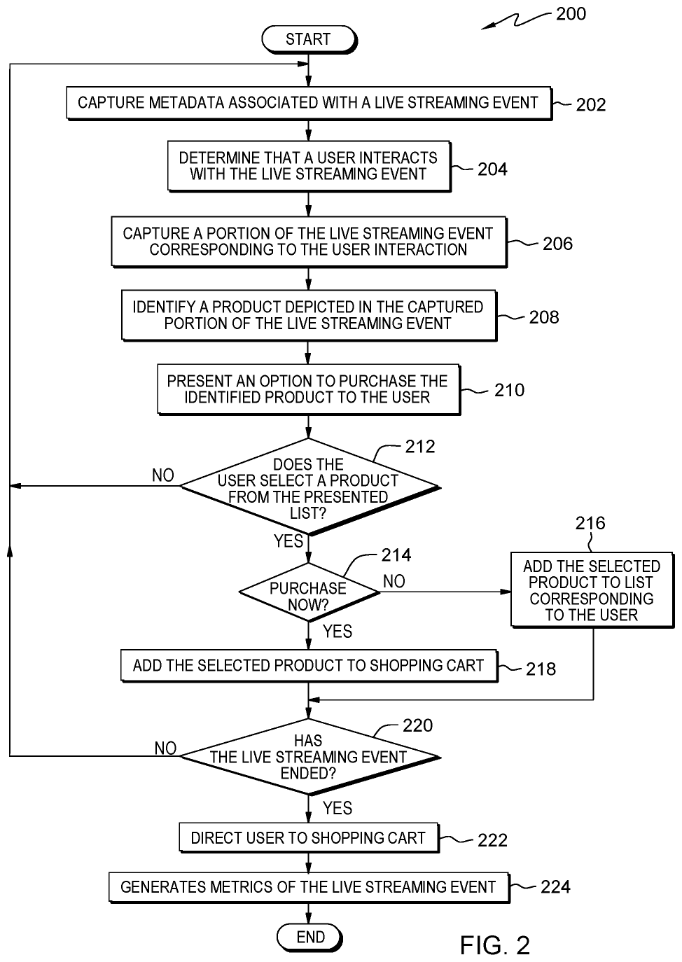

FIG. 2 is a flowchart depicting operational steps of product search program 200, a program for identifying and presenting products in a live streaming event in response to a user interaction with the live streaming event, in accordance with embodiments of the present invention. In one embodiment, product search program 200 initiates in response to a live streaming event starting. In another embodiment, product search program 200 initiates in response to server 140 capturing data of a live streaming event from audio/video source 120.

In step 202, product search program 200 captures metadata associated with a live streaming event. In various embodiments of the present invention, metadata is included or associated with streaming media of a live streaming event to identify and return products. In one embodiment, product search program 200 stores metadata that is in a live streaming event of audio/video source 120 in storage device 142. For example, product search program 200 stores audio and video data that includes structural and descriptive metadata of a product review of a blogger from a social media broadcast in memory of a server. In another embodiment, product search program 200 stores metadata that is associated with a live streaming event of audio/video source 120 in storage device 142. For example, product search program 200 stores metadata that corresponds to specific points in time with a video of a product review of a blogger in memory of a server.

In another embodiment, product search program 200 captures descriptive metadata of audio/video source 120 (e.g., descriptive metadata from a live stream), stores the descriptive metadata in storage device 142, and uses the descriptive metadata to identify products in audio/video source 120. For example, product search program 200 stores data that includes physical attributes of objects (e.g., a set of glasses with grey frames and orange lens) to identify products in a product review of a blogger from a social media broadcast. In yet another embodiment, product search program 200 captures descriptive metadata of audio/video source 120, stores the descriptive metadata in storage device 142, and uses the descriptive metadata to return products that correspond with the descriptive metadata. For example, product search program 200 stores data that includes physical attributes of objects (e.g., a set of glasses with grey frames and orange lens) to return products that share similar physical attributes.

In another example, product search program 200 captures metadata of audio/video source 120 to derive relevant information that the user can utilize to define user preferences in identifying and returning products. For example, product search program 200 captures metadata (e.g., sales completed, user interactions, products identified, etc.) of a product review of a blogger from a social media broadcast to derive relevant information that can be used by the user to define preferences for the types of products that product search program 200 identifies and returns.

In step 204, product search program 200 determines that a user interacts with the live streaming event. In various embodiments of the present invention, a user interaction occurs when an act of a user effects the live streaming event. In one embodiment, product search program 200 monitors user interface 132 of client device 130 to determine a user interaction with a live streaming event occurring on application 134. For example, product search program 200 monitors a user interface of a mobile device and detects a user interaction of the user clicking a “like” button during a product review of a blogger on a social media broadcast occurring on a web browser (e.g., application 134). Accordingly, product search program 200 determines that a user interaction with the live streaming event is occurring.

In another example, product search program 200 monitors a user interface of a tablet and detects acts of a user that indicate the user is commenting on a product review of a blogger on a social media broadcast using a live streaming software program (e.g., application 134). Accordingly, product search program 200 determines that a user interaction with the live streaming event is occurring. In yet another example, product search program 200 monitors a user interface of a tablet and detects activities of a user when the user shares a social media broadcast of a product review of a blogger occurring on a social media application (e.g., application 134). Accordingly, product search program 200 determines that a user interaction with the live streaming event is occurring. In various embodiments, product search program 200 monitors client device 130 and user interface 132 for any form of user interaction that is associated with viewing the live streaming event (i.e., any interaction defined by product search program 200 and/or a corresponding live streaming platform).

In step 206, product search program 200 captures a portion of the live streaming event corresponding to the user interaction. In various embodiments of the present invention, a corresponding portion is based on a defined set of user preferences, such as a portion captured simultaneously, a preference buffer time before, or a preference buffer time after a user interacts with a live streaming event. In one embodiment, product search program 200 captures a portion of a live streaming event of audio/video source 120 when the user of client device 130 interacts with the live streaming event occurring on application 134 using user interface 132. For example, product search program 200 takes a screenshot of the product review of a blogger on a social media broadcast when the user clicks a “like” button during the live streaming event on a web browser of a personal computer. In another embodiment, product search program 200 retrieves a captured portion (e.g., a video segment) of the live streaming event of audio/video source 120 from storage device 142 corresponding to the user interaction with the live streaming event of audio/video source 120. For example, product search program 200 retrieves from the memory of the server, a buffered portion of the product review of a blogger on a social media broadcast that corresponds with the user interaction.

In step 208, product search program 200 identifies a product depicted in the captured portion of the live streaming event. In various embodiments of the present invention, product search program 200 utilizes the captured portion as an input to visual recognition image or speech-to-text techniques for product identification. In one embodiment, product search program 200 utilizes visual recognition to identify products within the captured portion of the live streaming event of audio/video source 120. For example, product search program 200 analyzes a screenshot of the captured portion of the product review of the blogger from a social media broadcast using visual recognition. Additionally, product search program 200 identifies an object within the screenshot as a set of glasses, uses physical attributes and characteristics (e.g., descriptive metadata that includes the color of the frames and lenses) of the object to further identify of the set of glasses that includes grey frames and orange lenses, and associates a keyword that describes the object contained in the screenshot.

In another embodiment, product search program 200 utilizes speech-to-text to identify products within the captured portion of the live streaming event of audio/video source 120. For example, product search program 200 analyzes the buffered audio portion of the product review of the blogger from a social media broadcast for keywords (e.g., sun glasses, brand names, products, physical characteristics, etc.) and descriptive terms (e.g., orange lenses, grey frames, polarized lens, flexible, tints, impact protection, etc.) using speech-to text to identify a set of glasses with grey frames and orange lenses discussed within the buffered portion of the product review.

In step 210, product search program 200 presents an option to purchase the identified product to the user. In various embodiments of the present invention, product search program 200 utilizes a real-time dynamic data search to identify and return products from sources, which may be defined by a user, to populate a product list to present to the user.

In one embodiment, product search program 200 retrieves metadata corresponding to a user interaction with the live streaming event of audio/video source 120 from storage device 142, identifies products within a source of products that corresponds to objects of the metadata, and returns identified products to application 134 to present to the user. For example, product search program 200 retrieves physical attributes of the grey set of glasses with orange lenses from of the metadata of the screenshot of the product review of the blogger from a social media broadcast from the server, identifies a set of glasses on a listing of a site from the Internet that correspond to the set of glasses in the screenshot utilizing real-time dynamic data search, and returns the identified set of glasses a web browser.

In another embodiment, product search program 200 retrieves products from a defined set of sources (e.g., determined by preferences of a user). In one embodiment, product search program 200 returns products from a user defined source. For example, a broadcaster defines preferences that product search program 200 returns products from an inventory listing of a website of the broadcaster. In another example, a broadcaster defines a preference that product search program 200 can return products from an inventory listing of any site available over the Internet (e.g., a default preference). In another embodiment, a user defines a set of preferences that prioritizes sources from which product search program 200 returns products. For example, a broadcaster defines preferences that product search program 200 returns products from a listing of a website of the broadcaster before returning products from inventories of all sites available over the Internet.

In alternative embodiments, in response to the user interaction, product search program 200 presents a product or list of products to the user viewing the live streaming event on application 134. In one embodiment, product search program 200 returns products over network 110 to application 134 of client device 130 where the user is viewing the live streaming event of audio/video source 120. For example, product search program 200 returns a set of grey glasses with orange lenses to a web browser of a tablet where the user is viewing the product review of the blogger from a social media broadcast. Additionally, product search program 200 displays the list of products returned in a dialogue window while the user continues to view the product review. In another example, product search program 200 returns a set of grey glasses with orange lenses to a web browser and displays the set of grey glasses with orange lenses in a frame within the same window of the web browser as the product review of the blogger.

In decision step 212, product search program 200 determines whether the user selects a product from the presented product list. In one embodiment, product search program 200 determines whether the user selects a product presented on application 134 of client device 130. For example, product search program 200 monitors user interface 132 for a user interaction with the presented product list of step 210 in the web browser (e.g., application 134) and determines whether the user clicks on the set of grey glasses with orange lenses or does not interact with the presented product list. In another example, product search program 200 monitors user interface 132 for user interaction with a presented product list of step 210 in a dialogue window and determines that a user clicks a “cancel” button in the dialogue window.

If product search program 200 determines that the user is not selecting a product of the presented product list (decision step 212, “NO” branch), then product search program 200 returns to step 202 to capture metadata associated with the live streaming event. For example, if product search program 200 determines that the user closes the dialogue window that includes the set of grey glasses with orange lenses, then product search program 200 returns to step 202 to capture and store structural and descriptive metadata of a product review of a blogger from a social media broadcast in memory of the server (e.g., server 140). In another embodiment, product search program 200 monitors the client device for a user interaction with the product review of the blogger from a social media broadcast (i.e., monitors the live streaming event for a new user interaction in order to identify new products).

In decision step 214, product search program 200 determines whether the user provides input to purchase a selected product now. More specifically, in response to determining that a user selects a product on the presented product list (decision step 212, “YES” branch), product search program 200 presents options to complete a purchase or complete a purchase later. In one embodiment, product search program 200 determines whether the user provides input to complete a purchase of a product of the presented product list of step 210 or complete the purchase in the future. For example, product search program 200 monitors user interface 132 of client device 130 and detects a click of the user on the dialogue box and determines whether the user input is a selection to purchase the set of grey glasses with orange lenses now or in the future.

In step 216, product search program 200 adds the selected product to a list corresponding to a user. More specifically, in response to determining that the user chooses to purchase a product of the presented product list (of step 210) in the future (decision step 214, “NO” branch), product search program 200 adds the selected product to a list corresponding to the user (step 216). For example, when product search program 200 determines that the user chooses to purchase the set of grey glasses with orange lenses in the future, then product search program 200 adds the set of grey glasses with orange lenses to a list corresponding to the user (step 216). In various embodiments, the list corresponding to the user is a wish list (e.g., future shopping cart) or another type of list associated with the user (i.e., defined and/or indicated through user preferences).

In step 218, product search program 200 adds the selected product to a shopping cart. More specifically, in response to determining that the user chooses to purchase a product of the presented product list (decision step 214, “YES” branch), product search program 200 adds the selected product to a shopping cart of the user (step 218). For example, when product search program 200 determines that the user chooses to purchase the set of grey glasses with orange lenses, product search program 200 adds the set of grey glasses with orange lenses to the shopping cart (step 218) to allow the user to complete the purchase.

In decision step 220, product search program 200 determines whether the live streaming event ended. In one embodiment, product search program 200 determines whether the live streaming event of audio/video source 120 has ended. For example, product search program 200 monitors server 140 to determine whether server 140 continues to receive audio and video data of the product review of the blogger from a social media broadcast. In another embodiment, product search program 200 determines that the live streaming event of audio/video source 120 ended. For example, product search program 200 monitors server 140, detects that audio and video data of the product review of the blogger from a social media broadcast is no longer being stored into memory of the server and simultaneously broadcast, and determines that the product review of the blogger from a social media broadcast ended. In another example, product search program 200 monitors client device 130, detects that the user has closed the web browser (e.g., application 134), and determines that the user is no longer viewing the product review of the blogger from a social media broadcast. In yet another example, product search program 200 monitors client device 130, detects that the user has signed out of the live streaming application software (e.g., application 134), and determines that the user is no longer viewing the product review of the blogger from a social media broadcast.

If product search program 200 determines that the live streaming event has not ended (decision step 220, “NO” branch), then product search program 200 returns to step 202 to capture metadata associated with the live streaming event. For example, if product search program 200 determines that the product review of the blogger from a social media broadcast has not ended, then product search program 200 returns to step 202 to capture and store structural and descriptive metadata of a product review of a blogger from a social media broadcast in memory of the server.

In another embodiment, product search program 200 returns to step 202, and utilizes stored metadata and preferences of the user to refine the products returned corresponding to a user interaction with the live streaming event of audio/video source 120. For example, product search program 200 returns to step 202, and returns products corresponding to the user clicking the “like” button excluding the set of grey glasses with orange lenses that are present in a purchase history of the user. Additionally, product search program 200 can return products corresponding to a user interaction and a purchase history of the user. In this example, product search program 200 returns accessories associated with the set of grey glasses with orange lenses.

In step 222, product search program 200 directs the user to the shopping cart. In one embodiment, in response to product search program 200 determining that the live streaming event has ended (decision step 220, “YES” branch), product search program 200 presents the products added to the shopping cart and future shopping cart to the user on application 134 of client device 130 to complete a transaction. For example, product search program 200 adds the products the user added to the wish list to the shopping cart and presents the contents of the shopping cart to the user in a web browser where the user completes a transaction. In an alternative example, the user adds products of the shopping cart that the user does not wish to purchase back to a wish list.

In step 224, product search program 200 generates metrics of the live streaming event. In one embodiment, product search program 200 stores data of activities during the live streaming event (e.g., user interactions, products identified, products returned, completed transactions, etc.) in storage device 142 and generates metrics associated with the user and the live streaming event. For example, product search program 200 stores data about the number of user interactions with the product review, products identified, and completed transactions to generate metrics that are relevant to the blogger broadcasting the product review. In another example, product search program 200 stores data about the products purchased, returned, and identified to generate metrics relevant to the user. Additionally, product search program 200 uses the stored data to create a purchase history of the user, which is utilized to define the preferences of the user when returning products for presenting.

FIG. 3 depicts computer system 300, which is representative of server 140, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made. Computer system 300 includes processor(s) 301, cache 303, memory 302, persistent storage 305, communications unit 307, input/output (I/O) interface(s) 306, and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processor(s) 301 by holding recently accessed data, and data near recently accessed data, from memory 302.

Program instructions and data (e.g., software and data 310) used to practice embodiments of the present invention may be stored in persistent storage 305 and in memory 302 for execution by one or more of the respective processor(s) 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305. Software and data 310 can be stored in persistent storage 305 for access and/or execution by one or more of the respective processor(s) 301 via cache 303. With respect to audio/video source 120, software and data 310 includes media and meta data. With respect to server 140, software and data 310 includes product search program 200.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data (e.g., software and data 310) used to practice embodiments of the present invention may be downloaded to persistent storage 305 through communications unit 307.

I/O interface(s) 306 allows for input and output of data with other devices that may be connected to each computer system. For example, I/O interface(s) 306 may provide a connection to external device(s) 308, such as a keyboard, a keypad, a touch screen, and/or some other suitable input device. External device(s) 308 can also include portable computer readable storage media, such as, for example, thumb drives, portable optical or magnetic disks, and memory cards. Program instructions and data (e.g., software and data 310) used to practice embodiments of the present invention can be stored on such portable computer readable storage media and can be loaded onto persistent storage 305 via I/O interface(s) 306. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for identifying products in a live stream, the method comprising:
determining, by one or more processors, that a user provides an interaction with a live stream;
capturing, by one or more processors, a portion of the live stream that corresponds to the user interaction with the live stream;
identifying, by one or more processors, a first product that is depicted in the captured portion of the live stream that corresponds to the user interaction;
presenting, by one or more processors, an option to purchase the product to the user; and
determining, by one or more processors, whether the user selects to purchase the product.

2. The method of claim 1, wherein identifying the first product that is depicted in the captured portion of the live stream that corresponds to the first user interaction, comprises:
identifying, by one or more processors, an object within the captured portion of the live stream that corresponds to the first user interaction, wherein the captured portion of the live stream includes a screenshot of the live stream that corresponds with the first user interaction; and
generating, by one or more processors, a keyword that describes the object in the captured portion of the live stream based on metadata associated with captured portion of the live stream, wherein the metadata includes physical characteristics of the identified object.

3. The method of claim 1, further comprising:
in response to determining that the user selects to purchase the first product, adding, by one or more processors, the first product to a shopping cart associated with the user.

4. The method of claim 1, wherein presenting an option to purchase the first product to the user, further comprises:
determining, by one or more processors, a product listing on an online shopping website corresponding to the first product, wherein the online shopping website is identified based on preferences associated with the live stream.

5. The method of claim 1, further comprising:
in response to determining that the user selects to purchase the first product later, adding, by one or more processors, the first product to a list associated with the user.

6. The method of claim 5, further comprising:
in response to determining that the live stream has ended, presenting, by one or more processors, the list associated with the user; and
generating, by one or more processors, metrics of the live stream, wherein the generated metrics of the live stream are selected from the group consisting of: number of user interactions with the live stream, number of completed transactions, and number of products identified.

7. The method of claim 1, further comprising:
in response to determining that the live stream has not ended, determining, by one or more processors, that the user provides a second user interaction with the live stream;
capturing, by one or more processors, a second portion of the live stream that corresponds to the second user interaction; and
identifying, by one or more processors, a second product that is depicted in the captured portion of the live stream that corresponds to the second user interaction, wherein the identified second product is a different product than the identified first product.

8. A computer program product for identifying products in a live stream, the computer program product comprising:
one or more computer readable storage media and program instructions stored on the one or more computer readable storage media, the program instructions comprising:
program instructions to determine that a user provides an interaction with a live stream;
program instructions to capture a portion of the live stream that corresponds to the user interaction with the live stream;
program instructions to identify a first product that is depicted in the captured portion of the live stream that corresponds to the user interaction;
program instructions to present an option to purchase the product to the user; and
program instructions to determine whether the user selects to purchase the product.

9. The computer program product of claim 8, wherein the program instructions to identify a first product that is depicted in the captured portion of the live stream that corresponds to the user interaction, comprises program instructions to:
identify an object within the captured portion of the live stream that corresponds to the first user interaction, wherein the captured portion of the live stream includes a screenshot of the live stream that corresponds with the first user interaction; and
generate a keyword that describes the object in the captured portion of the live stream based on metadata associated with captured portion of the live stream, wherein the metadata includes physical characteristics of the identified object.

10. The computer program product of claim 8, further comprising program instructions, stored on the one or more computer readable storage media, to:
in response to determining that the user selects to purchase the first product, add the first product to a shopping cart associated with the user.

11. The computer program product of claim 8, wherein the program instructions to present an option to purchase the first product to the user further comprise program instructions to:
determine a product listing on an online shopping website corresponding to the first product, wherein the online shopping website is identified based on preferences associated with the live stream.

12. The computer program product of claim 8, further comprising program instructions, stored on the one or more computer readable storage media, to:
in response to determining that the user selects to purchase the first product later, add the first product to a list associated with the user.

13. The computer program product of claim 12, further comprising program instructions, stored on the one or more computer readable storage media, to:
in response to determining that the live stream has ended, present the list associated with the user; and
generate metrics of the live stream, wherein the generated metrics of the live stream are selected from the group consisting of: number of user interactions with the live stream, number of completed transactions, and number of products identified.

14. The computer program product of claim 8, further comprising program instructions, stored on the one or more computer readable storage media, to:
in response to determining that the live stream has not ended, determine that the user provides a second user interaction with the live stream;
capture a second portion of the live stream that corresponds to the second user interaction; and
identify a second product that is depicted in the captured portion of the live stream that corresponds to the second user interaction, wherein the identified second product is a different product than the identified first product.

15. A computer system for identifying products in a live stream, the computer system comprising:
one or more computer processors;
one or more computer readable storage media; and
program instructions stored on the computer readable storage media for execution by at least one of the one or more processors, the program instructions comprising:
program instructions to determine that a user provides an interaction with a live stream;
program instructions to capture a portion of the live stream that corresponds to the user interaction with the live stream;
program instructions to identify a first product that is depicted in the captured portion of the live stream that corresponds to the user interaction;
program instructions to present an option to purchase the first product to the user; and program instructions to determine whether the user selects to purchase the product.

16. The computer system of claim 15, wherein the program instructions to identify a first product that is depicted in the captured portion of the live stream that corresponds to the user interaction, comprises program instructions to:
identify an object within the captured portion of the live stream that corresponds to the first user interaction, wherein the captured portion of the live stream includes a screenshot of the live stream that corresponds with the first user interaction; and
generate a keyword that describes the object in the captured portion of the live stream based on metadata associated with captured portion of the live stream, wherein the metadata includes physical characteristics of the identified object.

17. The computer system of claim 15, further comprising program instructions, stored on the one or more computer readable storage media, to:
in response to determining that the user selects to purchase the first product, add the first product to a shopping cart associated with the user.

18. The computer system of claim 15, wherein the program instructions to present an option to purchase the first product to the user further comprise program instructions to:
in response to determining that the user selects to purchase the first product, add the first product to a shopping cart associated with the user.

19. The computer system of claim 18, further comprising program instructions, stored on the one or more computer readable storage media, to:
in response to determining that the live stream has ended, present the list associated with the user; and
generate metrics of the live stream, wherein the generated metrics of the live stream are selected from the group consisting of: number of user interactions with the live stream, number of completed transactions, and number of products identified.

20. The computer system of claim 15, further comprising program instructions, stored on the one or more computer readable storage media, to:
in response to determining that the live stream has not ended, determine that the user provides a second user interaction with the live stream;
capture a second portion of the live stream that corresponds to the second user interaction; and
identify a second product that is depicted in the captured portion of the live stream that corresponds to the second user interaction, wherein the identified second product is a different product than the identified first product.
